(19) United States
(12) Patent Application Publication
(10) Pub. No.: US 2025/0289324 A1
(43) Pub. Date: Sep. 18, 2025

(54) ELECTRIC WORK VEHICLE

(71) Applicant: Kubota Corporation, Osaka (JP)

(72) Inventors: Daisuke MIYAZAKI, Sakai-shi (JP); Makoto IMAIZUMI, Sakai-shi (JP)

(21) Appl. No.: 19/225,248

(22) Filed: Jun. 2, 2025

Related U.S. Application Data
(63) Continuation of application No. PCT/JP2023/031293, filed on Aug. 29, 2023.

(30) Foreign Application Priority Data
Dec. 27, 2022 (JP) 2022-210894

(51) Int. Cl. B60L 50/51; B60K 1/00; B60L 15/00; B60L 50/60; B60R 16/02

(52) U.S. Cl. CPC B60L 50/51; B60K 1/00; B60L 15/007; B60L 50/60; B60R 16/0207; B60L 2200/40; B60L 2210/40

(57) ABSTRACT

An electric work vehicle includes a harness connecting a front portion of a motor to an inverter, and a positioning mechanism including a first guide portion on one of the motor and a support and a second guide portion on the other of the motor and the support, and configured to position the motor relative to the support as viewed in the front-back direction, by the first guide portion and the second guide portion coming in contact with each other. The positioning mechanism is configured such that, at a time of attaching the motor to the support, the first guide portion is contactable with the second guide portion while a protrusion is forward of a support front surface.

### CROSS REFERENCE TO RELATED APPLICATIONS

This application claims the benefit of priority to Japanese Patent Application No. 2022-210894 filed on Dec. 27, 2022 and is a Continuation Application of PCT Application No. PCT/JP2023/031293 filed on Aug. 29, 2023. The entire contents of each application are hereby incorporated herein by reference.

### BACKGROUND OF THE INVENTION

### 1. Field of the Invention

The present invention relates to electric work vehicles each including a battery and a motor.

### 2. Description of the Related Art

A known example of an electric work vehicle such as described above is disclosed in JP 2021-953A. This electric work vehicle (“tractor” in JP 2021-953A) includes a motor drivable by power supplied from a battery (“drive battery” in JP 2021-953A).

This electric work vehicle includes an inverter that converts direct-current electric power from the battery into alternating-current electric power and supplies the alternating-current electric power to the motor.

This motor is supported by a front support frame and a support (“back support frame” in JP 2021-953A). More specifically, the front support frame supports a front portion of the motor from below. The support contacts a back end portion of the motor and supports a back portion of the motor.

The motor has an output shaft that extends rearward through the support.

### SUMMARY OF THE INVENTION

The electric work vehicle described in JP 2021-953A can conceivably be constituted without the front support frame. In this case, the motor is held in a cantilever manner by the support. In such a configuration, if a recess that is recessed rearward is formed in the front surface of the support and a protrusion that fits into the recess is formed on a back end portion of the motor, the motor can, at the time of being attached to the support, be positioned relative to the support as viewed in a front-back direction, as a result of the protrusion fitting into the recess.

However, in a configuration including such a recess and a protrusion, it is perceived that, in the case where the support is made of a material having a comparatively high hardness (e.g., iron), the surface of the protrusion could be scratched when the recess and the protrusion are fitted together, due to the protrusion coming in contact with the recess or the periphery thereof.

Also, it is perceived that, in the case where the electric work vehicle described in JP 2021-953A is provided with a harness that connects the motor to the inverter, a connector of the motor to the harness or the harness itself will interfere with attaching the motor to the support. As a result, it is perceived that smoothly attaching the motor to the support will not be possible.

Example embodiments of the present invention provide electric work vehicles in each of which, at a time of attaching a motor to a support, the motor is positioned and smoothly attached, and scratching of a surface of the motor is readily avoided.

An electric work vehicle according to an example embodiment of the present invention includes a battery, a motor held by a support and drivable by power supplied from the battery, an inverter configured to convert direct-current electric power from the battery into alternating-current electric power and supply the alternating-current electric power to the motor, and a harness connecting a front portion of the motor to the inverter, the inverter being configured to supply power to the motor through the harness, the motor being held by the support with an output shaft of the motor extending rearward through the support, the support including a support front surface that is a front surface of the support in which a recess is recessed rearward, the motor including a contact surface contacting the support front surface and a protrusion protruding rearward from the contact surface and fitting into the recess, the protrusion being made of a first material, the support being made of a second material having a higher hardness than the first material, and includes a positioning mechanism including a first guide portion provided on one of the motor and the support and a second guide portion provided on the other of the motor and the support, and configured to position the motor relative to the support as viewed in a front-back direction, by the first guide portion and the second guide portion coming in contact with each other, and at a time of attaching the motor to the support, the first guide portion and the second guide portion of the positioning mechanism are contactable with each other while the protrusion is forward of the support front surface.

According to the above configuration, at the time of attaching the motor to the support, the first guide portion and the second guide portion come in contact with each other before the protrusion fits into the recess. The motor is positioned as a result. Furthermore, by moving the motor rearward while keeping the first guide portion and the second guide portion in contact with each other, the protrusion is fitted into the recess with the motor positioned relative to the support as viewed in the front-back direction. The surface of the protrusion is thus unlikely to be scratched, compared to the case where the protrusion is fitted into the recess without positioning the motor relative to the support as viewed in the front-back direction (i.e., with the motor being freely moveable relative to the support as viewed in the front-back direction).

Moreover, according to the above configuration, the motor is attached to the support from the front, and the harness connecting the motor to the inverter is connected to a front portion of the motor. Thus, neither the connector of the motor to the harness nor the harness itself is likely to interfere with attaching the motor to the support, compared to the case where the harness is connected to a back portion of the motor.

That is, according to the above configuration, an electric work vehicle is realized in which, at the time of attaching the motor to the support, the motor is positioned and smoothly attached, and scratching of the surface of the motor is readily avoided.

Furthermore, in an example embodiment of the present invention, preferably the first guide portion includes a pin extending in the front-back direction, the second guide portion includes a hole that fits together with the pin, the positioning mechanism includes a plurality of positioning portions, and the positioning portions each include one first guide portion and one second guide portion that correspond to each other.

According to the above configuration, the positioning mechanism that positions the motor relative to the support as viewed in the front-back direction is realized by a comparatively simple configuration. Moreover, by fitting a plurality of sets of pins and holes together, the motor is prevented from rotating relative to the support as viewed in the front-back direction while being attached to the support. Thus, attachment of the motor to the support is facilitated, compared to the case where the positioning mechanism includes only one pin and one hole.

Furthermore, in an example embodiment of the present invention, preferably the positioning mechanism includes at least three positioning portions.

In the case where the positioning mechanism includes only two positioning portions, it is conceivable to provide one positioning portion on each of the left and right of the axis of the output shaft of the motor, for example. In this case, if the axis of the output shaft is on a straight line connecting the two positioning portions and the respective positioning portions are equidistant from the axis of the output shaft as viewed in the front-back direction, it is perceived that a worker attaching the motor to the support could accidentally attach the motor upside down.

Here, according to the above configuration of an example embodiment of the present invention, by looking at the disposition of the pins and holes, a worker attaching the motor to the support can more readily obtain an accurate grasp of the correspondence relation between the pins and holes, compared to the case where the positioning mechanism has only two positioning parts. Thus, a worker attaching the motor to the support is unlikely to accidentally attach the motor upside down.

Furthermore, in an example embodiment of the present invention, preferably the positioning mechanism includes three positioning portions, and the three positioning portions are positioned to define a triangle with vertices at respective positions arranged so as not to define an equilateral triangle, as viewed in the front-back direction.

In the case where the positioning mechanism includes only three positioning portions, it is conceivable to position the positioning portions such that a triangle whose vertices are the respective positions of the positioning portions is an equilateral triangle, for example. In this configuration in which the positioning portions are equidistant from the axis of the output shaft as viewed in the front-back direction, it is perceived that a worker attaching the motor to the support could attach the motor so as to be rotated 120 degrees to the left or right from the correct orientation.

Here, according to the above configuration of an example embodiment of the present invention, the three positioning portions are positioned such that the triangle whose vertices are the respective positions of the three positioning portions is not an equilateral triangle. All of the pins can thus be fitted into the holes only if the motor is correctly oriented as viewed in the front-back direction. Thus, a worker attaching the motor to the support can be prevented from attaching the motor so as to be rotated 120 degrees to the left or right from the correct orientation as described above.

Furthermore, in an example embodiment of the present invention, preferably the positioning portions are positioned upward and downward of an axis of the output shaft.

In the case where the positioning portions are concentrated upward or downward of the axis of the output shaft, the individual pins fitted into the corresponding holes tend to be subject to a comparatively large amount of stress from the motor, due to the weight of the motor and the like. Thus, to prevent the pins from being damaged by this stress, the pins would need to be formed from a material having a comparatively high strength. Manufacturing costs would thereby tend to increase.

Here, according to the above configuration of an example embodiment of the present invention, the pins are unlikely to be subject to a comparatively large amount of stress from the motor, compared to the case where the positioning portions are concentrated upward or downward of the axis of the output shaft. Accordingly, it is possible to avoid incurring increased manufacturing costs in order to prevent the pins from being damaged.

Furthermore, in an example embodiment of the present invention, preferably the positioning portions upward of the axis are greater in number than the positioning portions downward of the axis.

The individual pins fitted into the corresponding holes are subject to stress from the motor due to the weight of the motor and the like. Here, among the pins of the positioning mechanism, the total amount of stress applied by the motor to the pins positioned upward of the axis tends to be greater than that applied to the pins positioned downward of the axis. Thus, the case where the number of pins positioned upward of the axis is comparatively small, the individual pins positioned upward of the axis tend to be subject to a comparatively large amount of stress. Thus, to prevent the pins from being damaged by this stress, the pins would need to be formed from a material having a comparatively high strength. Manufacturing costs would thereby tend to increase.

Here, according to the above configuration of an example embodiment of the present invention, a comparatively large number of pins are positioned upward of the axis. Thus, the individual pins positioned upward of the axis are unlikely to be subject to a comparatively large amount of stress. Accordingly, it is possible to avoid incurring increased manufacturing costs in order to prevent the pins from being damaged.

Furthermore, in an example embodiment of the present invention, preferably the pin is attached to a pin attachment surface that is the support front surface or the contact surface, and protrudes forward or rearward from the pin attachment surface, and the pin is longer from the pin attachment surface to a protruding end thereof than a protruding length of the protrusion.

According to the above configuration, it is easy to reliably realize a configuration in which the pins are contactable with the holes while the protrusion is forward of the support front surface, at the time of attaching the motor to the support. That is, according to the above configuration, it is easy to reliably realize an electric work vehicle in which the motor can be positioned, and scratching the surface of the motor is readily avoided, at the time of attaching the motor to the support.

Furthermore, in an example embodiment of the present invention, preferably the protruding end of the pin includes a tapered portion, and the pin is longer from the pin attachment surface to a base end of the tapered portion than the protruding length of the protrusion.

According to the above configuration, the protruding ends of the pins are tapered, making it easy for a worker to insert the pins into the holes at the time of attaching the motor to the support.

The positioning accuracy of the motor as viewed in the front-back direction increases as the tapered portion enters deeper into the hole, from when the distal end of the tapered portion begins to enter the hole until when the base end of the tapered portion enters the hole. Also, according to the above configuration, the entirety of the tapered portion from the distal end to the base end can be inserted into the hole while the protrusion is forward of the support front surface. The motor is thus positioned with high accurately before the protrusion fits into the recess, at the time of attaching the motor to the support.

Furthermore, in an example embodiment of the present invention, preferably the pin is attached to the motor, and the hole is provided in the support.

In the case where the pins are attached to the support and the holes are provided in the motor, it is perceived that the periphery of the holes in the motor could be scratched, due to the pins coming in contact with the holes or the periphery thereof when the pins and the holes are fitted together.

Here, according to the above configuration of an example embodiment of the present invention, the pins are attached to the motor, and the holes are provided in the support. Thus, it is possible to avoid the motor being scratched in the manner described above.

Furthermore, in an example embodiment of the present invention, preferably the motor is fastened to the support by a fastener, and the positioning portions are inward of the fastener in a radial direction of the output shaft.

In the case where the positioning portions are outward of the fastener, the holes are located at positions close to the outer periphery of whichever of the motor and the support the holes are provided in as viewed in the front-back direction. It is perceived that this could result in reduced strength around the holes. Thus, measures such as reinforcing the periphery of the holes would likely be needed. Manufacturing costs would thereby tend to increase.

Here, according to the above configuration of an example embodiment of the present invention, the holes are located inward of the fastener. Thus, reduced strength around the holes as described above is readily avoided. Accordingly, measures such as reinforcing the periphery of the holes are unlikely to be needed. An increase in manufacturing costs can thus be readily avoided. Furthermore, in an example embodiment of the present invention, preferably the support holds the motor in a cantilever manner.

According to the above example embodiments of the present invention, a support structure of a motor is simple, compared to the case where the motor is not held in a cantilever manner (e.g., is held on two sides). An increase in manufacturing costs is thus readily reduced or prevented.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a left-side view of a tractor.

FIG. 2 is a partial cutaway plan view showing the configuration of a motor and the like.

FIG. 3 is a front view showing the configuration of a support and the like.

FIG. 4 is a cross-sectional view showing the configuration of positioning portions and the like.

FIG. 5 is a partial cutaway left-side view showing the configuration of the motor and the like.

FIG. 6 is a partial cutaway left-side view showing the configuration of the motor and the like in another example embodiment (10) of the present invention.

### DETAILED DESCRIPTION OF THE EXAMPLE EMBODIMENTS

Example embodiments of the present invention will be described based on the drawings. Note that, in the following description, unless stated otherwise, the directions of arrows F, B, L and R in the diagrams respectively indicate “forward”, “back”, “left”, and “right”. Also, the directions of arrows U and D respectively indicate “up” and “down”.

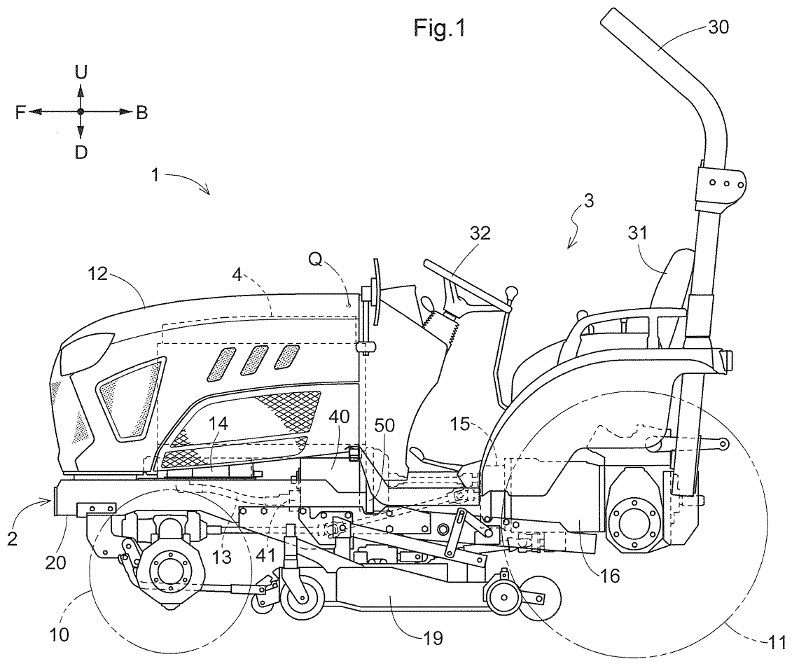

Hereinafter, example embodiments of a tractor 1 (corresponding to an “electric work vehicle”) will be described. As shown in FIG. 1, the tractor 1 includes left and right front wheels 10, left and right rear wheels 11, and a cover 12.

The tractor 1 includes a body frame 2 and a driver section 3. The body frame 2 is supported by the left and right front wheels 10 and the left and right rear wheels 11.

The cover 12 is at a front portion of the body. The driver section 3 is rearward of the cover 12. In other words, the cover 12 is forward of the driver section 3.

The driver section 3 includes a protective frame 30, a driver's seat 31, and a steering wheel 32. An operator can sit in the driver's seat 31. The operator can thus board the driver section 3. The left and right front wheels 10 are steered by the operation of the steering wheel 32. The operator is able to perform various operations in the driver section 3.

The tractor 1 includes a battery 4. Also, the cover 12 is swingable about an opening/closing axis Q extending in a left-right direction of the body. The cover 12 is thus openable and closeable. When closed, the cover 12 covers the battery 4.

The tractor 1 includes an inverter 14 and a motor 40. The motor 40 is downward of the battery 4. Also, the motor 40 is rearward of the inverter 14.

The battery 4 supplies power to the inverter 14. The inverter 14 converts direct-current electric power from the battery 4 into alternating-current electric power and supplies the alternating-current electric power to the motor 40. The motor 40 is then driven by the alternating-current electric power supplied from the inverter 14.

That is, the tractor 1 includes the inverter 14 that converts direct-current electric power from the battery 4 into alternating-current electric power and supplies the alternating-current electric power to the motor 40.

As shown in FIG. 1, the tractor 1 includes a harness 13. Also, the motor 40 has a connector 41. The connector 41 is in a front portion of the motor 40. The harness 13 connects the connector 41 to a front lower end portion of the inverter 14. That is, the tractor 1 includes the harness 13 connecting the front portion of the motor 40 to the inverter 14. The inverter 14 supplies power to the motor 40 through the harness 13.

The tractor 1 includes a hydrostatic continuously variable transmission 15 and a transmission 16. The motor 40 outputs a driving force that is distributed to the hydrostatic continuously variable transmission 15 and work machinery 19. The driving force received from the motor 40 is adjusted for speed and torque by the hydrostatic continuously variable transmission 15 and transmitted to the transmission 16.

The hydrostatic continuously variable transmission 15 includes a hydraulic pump and a hydraulic motor, and is capable of changing the transmission ratio in a stepless manner. Since the hydrostatic continuously variable transmission 15 being provided with such a configuration is known, a detailed description relating the hydrostatic continuously variable transmission 15 will be omitted.

The driving force transmitted to the transmission 16 is adjusted for speed and torque by a geared transmission mechanism provided in the transmission 16 and distributed to the left and right front wheels 10 and the left and right rear wheels 11. The left and right front wheels 10 and the left and right rear wheels 11 are thereby driven.

The work machinery 19 is drivable by the driving force from the motor 40. In the present example embodiment, the work machinery 19 is, specifically, a mower. Example embodiments of the present invention are, however, not limited thereto, and the work machinery 19 may be machinery such as a tiller or a fertilizer applicator, for example.

As shown in FIG. 1, the body frame 2 includes left and right main frames 20 and a support 50. The left and right main frames 20 extend in a front-back direction. The support 50 is plate shaped. The support 50 is oriented perpendicular to the front-back direction. The front surface of the support 50 contacts the back end of the left and right main frames 20. The support 50 is joined to the back end of the left and right main frames 20. The support 50 may, for example, be joined to the back end of the left and right main frames 20 by welding, but is not particularly limited thereto.

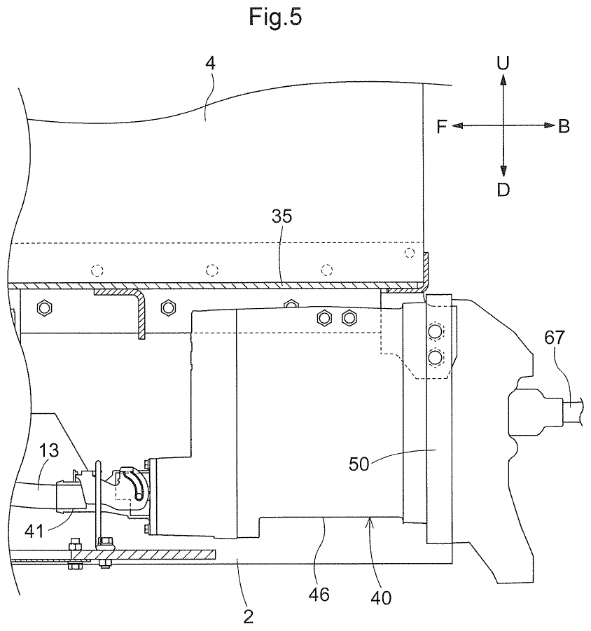

The motor 40 is held by the support 50. That is, the tractor 1 includes the motor 40 held by the support 50 and drivable by power supplied from the battery 4. Note that, as shown in FIG. 5, the battery 4 is supported by a support frame 35. The support frame 35 is supported by the body frame 2.

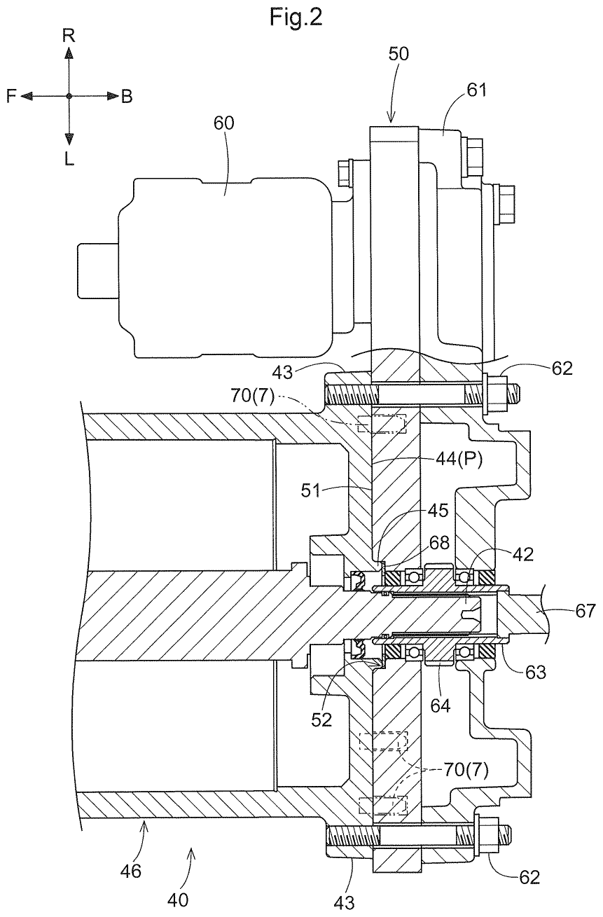

As shown in FIG. 2, the tractor 1 includes an oil pump 60. The oil pump 60 is provided on the right side of the body. The oil pump 60 is drivable by the driving force from the motor 40. The oil pump 60 then supplies hydraulic fluid to various portions of the body.

The structure to transmit the driving force to the oil pump 60 will now be described in detail. As shown in FIGS. 2 and 5, the motor 40 is held in a cantilever manner by the support 50, with the back end portion of the motor 40 held by the support 50. The output shaft 42 of the motor 40 extends rearward through the support 50. That is, the motor 40 is held in a cantilever manner by the support 50, with the output shaft 42 of the motor 40 extending rearward through the support 50.

Rearward of the support 50 is a gear case 61, as shown in FIG. 2. Also, on a back end portion of the motor 40 is a flange 43 extending radially outward of the output shaft 42. The flange 43, the support 50, and the gear case 61 are fastened together by a plurality of fasteners 62. That is, the motor 40 is fastened to the support 50 by the fasteners 62.

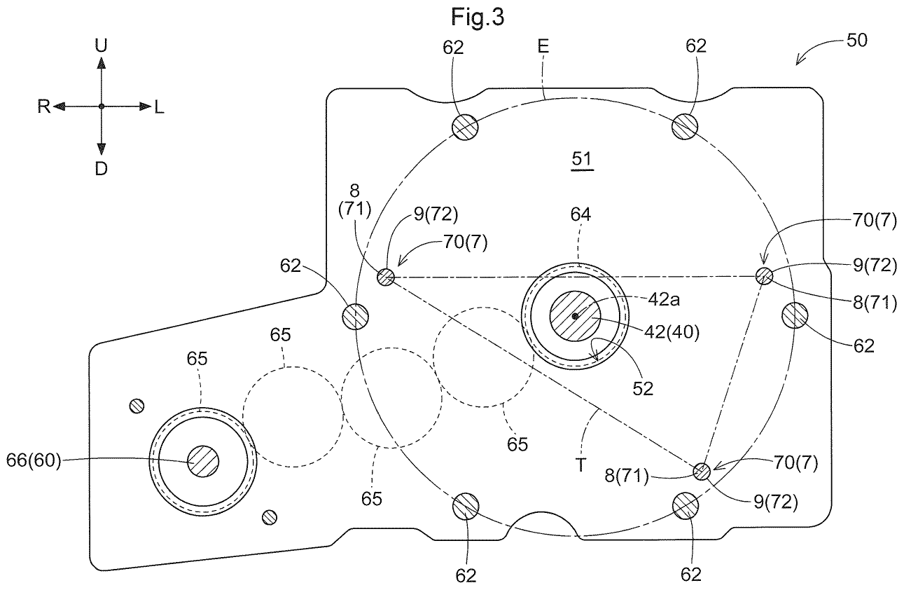

In the present example embodiment, six fasteners 62 are provided, for example, as shown in FIG. 3. The present invention is, however, not limited thereto, and five or fewer fasteners 62 or seven or more fasteners 62 may be provided.

The fasteners 62 in the present example embodiment are, specifically, bolts, for example. However, example embodiments of the present invention are not limited thereto. The fasteners 62 may, for example, be bolts and nuts, or by rivets or the like.

As shown in FIG. 2, the output shaft 42 includes a tube 63 extending in the front-back direction attached thereto. The output shaft 42 is inserted into the tube 63. The tube 63 passes through the support 50 and the gear case 61.

The tube 63 has an input gear 64 fixed thereto. Note that the input gear 64 may be integrated with the tube 63 or may be separated from the tube 63.

The tube 63 rotates integrally with the output shaft 42. The driving force from the output shaft 42 is thus transmitted to the input gear 64 via the tube 63.

As shown in FIG. 3, the tractor 1 includes four transmission gears 65, for example. The driving force that the output shaft 42 transmits to the input gear 64 is transmitted to an input shaft 66 of the oil pump 60, via the four transmission gears 65. In this configuration, the oil pump 60 is drivable by the driving force from the output shaft 42.

Note that the input gear 64 and the transmission gears 65 are housed in the space enclosed by the support 50 and the gear case 61.

As shown in FIG. 2, the tube 63 has a transmission shaft 67 coupled to the back end portion thereof. The driving force that the tube 63 transmits to the transmission shaft 67 is distributed to the hydrostatic continuously variable transmission 15 (see FIG. 1) and the work machinery 19 (see FIG. 1).

As shown in FIGS. 2 to 4, the support 50 includes a support front surface 51 in which a recess 52 is located. The support front surface 51 is the front surface of the support 50. The recess 52 is recessed rearward. That is, the recess 52 recessed rearward is provided in the support front surface 51 which is the front surface of the support 50.

As shown in FIG. 3, the recess 52 is ring shaped around a hole (opening) in the support 50. The output shaft 42 passes through the hole.

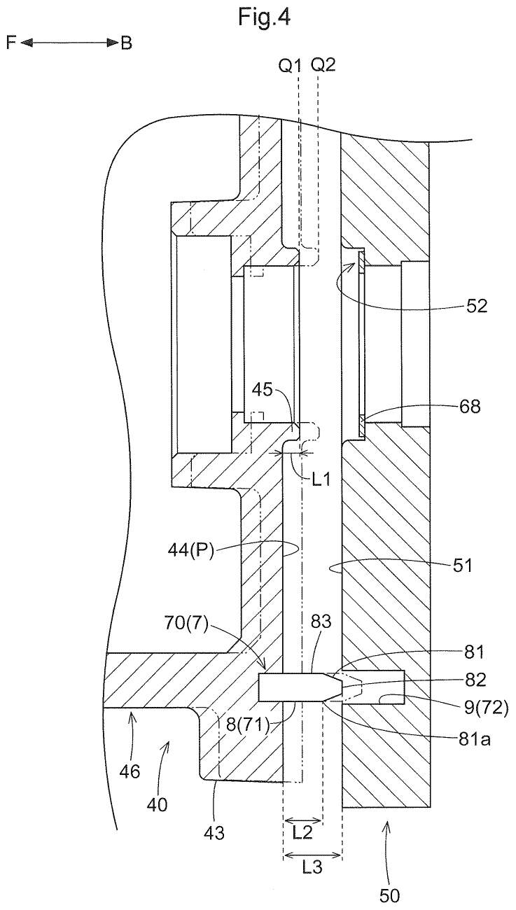

As shown in FIGS. 2 and 4, the motor 40 includes a contact surface 44 and a protrusion 45. The contact surface 44 is a vertical surface on the back end portion of the motor 40. The contact surface 44 is a back surface of the motor 40. The contact surface 44 contacts the support front surface 51, with the motor 40 attached to the support 50.

The protrusion 45 protrudes rearward from the contact surface 44. Also, the protrusion 45 is tubular (ring shaped) extending in the front-back direction. The output shaft 42 passes through the inside of the protrusion 45. The protrusion 45 has a shape that fits into the recess 52. That is, the motor 40 includes the contact surface 44 that contacts the support front surface 51, and includes the protrusion 45 that protrudes rearward from the contact surface 44 and that fits into the recess 52.

Note that, as shown in FIGS. 2 and 4, a ring-shaped collar 68 may be attached to the recess 52. With the motor 40 attached to the support 50, the back end of the protrusion 45 may be in contact with the collar 68.

As shown in FIGS. 2 and 4, the motor 40 includes a housing 46. The housing 46 is columnar (substantially columnar). The housing 46 includes the flange 43, the contact surface 44, and the protrusion 45.

The housing 46 is made of a predetermined first material. That is, the protrusion 45 is made of the first material. The first material may, for example, be an aluminum alloy or another metal, but is not particularly limited there.

The support 50 is made of a predetermined second material. The second material has a higher hardness than the first material. That is, the support 50 is made of the second material having a higher hardness than the first material. The second material may, for example, be iron or another metal, but is not particularly limited thereto.

As shown in FIG. 2, the tractor 1 includes a positioning mechanism 7. The positioning mechanism 7 positions the motor 40 relative to the support 50 as viewed in the front-back direction. Hereinafter, the positioning mechanism 7 will be described in detail.

As shown in FIG. 2, the positioning mechanism 7 includes a plurality of positioning portions 70. The positioning mechanism 7 preferably has three or more positioning portions 70, but is not particularly limited thereto. In the present example embodiment, the positioning mechanism 7 has three positioning portions 70, for example.

As shown in FIGS. 3 and 4, the positioning portions 70 each include a first guide portion 71 and a second guide portion 72 that correspond to each other. In the present example embodiment, the first guide portion 71 includes a pin 8 extending in the front-back direction. The second guide portion 72 includes a hole 9 that fits together with the pin 8. Note that the positioning portions 70 all have the same structure. The positioning portion 70 shown in FIG. 4 is the leftmost positioning portion 70 of the three positioning portions 70 shown in FIGS. 2 and 3.

As shown in FIG. 4, the pins 8 are attached to the motor 40.

The holes 9 are provided in the support 50. That is, in the present example embodiment, the motor 40 is provided with the first guide portions 71, and the support 50 is provided with the second guide portions 72. However, example embodiments of the present invention are not limited thereto, and the support 50 may be provided with the first guide portions 71 (pins 8), and the motor 40 may be provided with the second guide portions 72 (holes 9).

The positioning mechanism 7 positions the motor 40 relative to the support 50 as viewed in the front-back direction, by the first guide portions 71 and the second guide portions 72 coming in contact with each other. More specifically, the positioning mechanism 7 positions the motor 40 relative to the support 50 as viewed in the front-back direction, by the pins 8 and the corresponding holes 9 fitting together. Note that, in the present specification, “fitting” is a specific example of “contacting”.

That is, the tractor 1 includes the positioning mechanism 7 that includes the first guide portions 71 provided on one of the motor 40 and the support 50, the second guide portions 72 provided on the other of the motor 40 and the support 50, and that positions the motor 40 relative to the support 50, by the first guide portions 71 and the second guide portions 72 coming in contact with each other.

As shown in FIG. 3, the output shaft 42 includes an axis 42a that the positioning mechanism 7 positions in the center of the hole (opening) enclosed by the recess 52, as viewed in the front-back direction.

FIG. 3 shows a triangle T. The three vertices of the triangle T are the respective positions of the three positioning portions 70 as viewed in the front-back direction, for example. In the present example embodiment, the triangle T is not an equilateral triangle, as shown in FIG. 3. That is, the three positioning portions 70 are positioned such that the triangle T whose vertices are the respective positions of the three positioning portions 70 is not an equilateral triangle, as viewed in the front-back direction.

As shown in FIG. 3, two of the three positioning portions 70 are upward of the axis 42a. The remaining one of the three positioning portions 70 is downward of the axis 42a. That is, the positioning portions 70 are distributed upward and downward of the axis 42a of the output shaft 42. Also, the positioning portions 70 upward of the axis 42a are greater in number than the positioning portions 70 downward of the axis 42a.

FIG. 3 shows a disposition circle E. The disposition circle E is centered on the axis 42a as viewed in the front-back direction. The fasteners 62 are on the disposition circle E. The positioning portions 70 are all inward of the disposition circle E. That is, the positioning portions 70 are inward of the fasteners 62 in the radial direction of the output shaft 42.

As shown in FIG. 4, the pins 8 are attached to a pin attachment surface P, which is the support front surface 51 or the contact surface 44. In the present example embodiment, the pin attachment surface P is the contact surface 44. That is, the pins 8 are attached to the contact surface 44. The pins 8 protrude rearward from the pin attachment surface P.

However, example embodiments of the present invention are not limited thereto, and the pin attachment surface P may be the support front surface 51. In this case, the pins 8 protrude forward from the pin attachment surface P. Also, in this case, the holes 9 may be provided in the motor 40.

That is, the pins 8 are attached to the pin attachment surface P, which is the support front surface 51 or the contact surface 44, and protrude forward or rearward from the pin attachment surface P.

As shown in FIG. 4, the pins 8 each include a tapered portion 81 and a body 83. The tapered portion 81 is provided on the protruding end of the pin 8. That is, on the protruding end of the pin 8 is provided on the tapered portion 81. The tapered portion 81 decreases in diameter toward the distal end. The body 83 is columnar. The body 83 has the same diameter as a base end 81a of the tapered portion 81. Also, the body 83 has substantially the same diameter as the hole 9. The front end portion (root portion) of the body 83 is fixedly embedded in the motor 40. FIG. 4 shows a first length L1, a second length L2, and a third length L3. The first length L1 is the protruding length of the protrusion 45. In other words, the first length L1 is the length of the protrusion 45 in the front-back direction from the contact surface 44 to the back end thereof.

The second length L2 is the length of the pin 8 in the front-back direction from the pin attachment surface P to the base end 81a of the tapered portion 81.

The third length L3 is the length of the pin 8 in the front-back direction from the pin attachment surface P to the protruding end 82 thereof.

As shown in FIG. 4, the second length L2 is longer than the first length L1. The third length L3 is longer than the second length L2. That is, the third length L3 is longer than the first length L1.

That is, the length of the pin 8 from the pin attachment surface P to the protruding end 82 thereof is longer than the protruding length of the protrusion 45. Also, the length of the pin 8 from the pin attachment surface P to the base end 81a of the tapered portion 81 is longer than the protruding length of the protrusion 45.

FIG. 4 shows the motor 40 attached to the support 50. Note that the output shaft 42 is omitted in FIG. 4. Also, FIG. 4 shows a first position Q1 and a second position Q2. The first position Q1 and the second position Q2 are both forward of the support front surface 51. The first position Q1 is forward of the second position Q2.

At the time of attaching the motor 40 to the support 50, the position of the protruding end 82 of the pin 8 in the front-back direction coincides with the position of the support front surface 51 in the front-back direction, in a case of the back end of the protrusion 45 being at the first position Q1. That is, when attaching the motor 40 to the support 50, the pin 8 begins to enter the hole 9 at the point in time that the back end of the protrusion 45 reaches the first position Q1. At this point in time, the back end of the protrusion 45 is forward of the support front surface 51. That is, at this point in time, the protrusion 45 has not yet begun to fit into the recess 52.

Then, when the back end of the protrusion 45 moves to a position rearward of the first position Q1 and forward of the second position Q2 as a result of the motor 40 further approaching the support 50, the pin 8 is contactable with the hole 9. For example, if the motor 40 deviates left or right from the appropriate position at this time, the pin 8 will come in contact with the hole 9. As a result, the motor 40 can be prevented from deviating further in the left-right direction.

At this time, the pin 8 is contactable with the hole 9 while the back end of the protrusion 45 is forward of the support front surface 51. That is, the positioning mechanism 7 is configured such that, when attaching the motor 40 to the support 50, the first guide portion 71 is contactable with the second guide portion 72 while the protrusion 45 is forward of the support front surface 51.

Then, when the back end of the protrusion 45 reaches the second position Q2 as a result of the motor 40 further approaching the support 50, the position of the base end 81a in the front-back direction coincides with the position of the support front surface 51 in the front-back direction, as shown by an imaginary line in FIG. 4. That is, when attaching the motor 40 to the support 50, the body 83 begins to enter the hole 9, at the point in time that the back end of the protrusion 45 reaches the second position Q2. In other words, when attaching the motor 40 to the support 50, the body 83 of the pin 8 begins to fit into the hole 9, at the point in time that the back end of the protrusion 45 reaches the second position Q2. At this point in time, the back end of the protrusion 45 is forward of the support front surface 51. That is, at this point in time, the protrusion 45 has not yet begun to fit into the recess 52.

Then, as a result of the motor 40 further approaching the support 50, the protrusion 45 fits into the recess 52.

According to the configuration described above, at the time of attaching the motor 40 to the support 50, the first guide portion 71 and the second guide portion 72 come in contact with each other before the protrusion 45 fits into the recess 52. The motor 40 can thereby be positioned. Furthermore, by moving the motor 40 rearward while keeping the first guide portion 71 and the second guide portion 72 in contact with each other, the protrusion 45 can be fitted into the recess 52, with the motor 40 positioned relative to the support 50 as viewed in the front-back direction. The surface of the protrusion 45 is thus unlikely to be scratched, compared to the case where the protrusion 45 is fitted into the recess 52 without positioning the motor 40 relative to the support 50 as viewed in the front-back direction (with the motor 40 freely moveable relative to the support 50 as viewed in the front-back direction).

Moreover, according to the configuration described above, the motor 40 is attached to the support 50 from the front, and the harness 13 connecting the motor 40 to the inverter 14 is connected to a front portion of the motor 40. Thus, neither the connector 41 of the motor 40 to the harness 13 nor the harness 13 itself is likely to interfere with attaching the motor 40 to the support 50, compared to the case where the harness 13 is connected to a back portion of the motor 40.

That is, according to the configuration described above, a tractor 1 can be realized in which, at the time of attaching the motor 40 to the support 50, the motor 40 can be positioned and smoothly attached, and scratching of the surface of the motor 40 is readily avoided.

As long as the motor 40 can be positioned relative to the support 50 as viewed in the front-back direction, the first guide portion 71 need not include the pin 8, and the second guide portion 72 need not include the hole 9. For example, the first guide portion 71 and the second guide portion 72 may include a rail and a roller that is guided by the rail.

The positioning mechanism 7 may include only one positioning portion 70.

The triangle T may be an equilateral triangle.

All of the positioning portions 70 may be positioned upward of the axis 42a or may be positioned downward of the axis 42a.

The positioning portions 70 upward of the axis 42a may be fewer in number than the positioning portions 70 downward of the axis 42a, or may be equal in number thereto.

The pin 8 need not be provided with the tapered portion 81.

The positioning portions 70 may be located outward of the fasteners 62 in the radial direction of the output shaft 42.

The positioning portions 70 may be positioned on the disposition circle E.

The position and shape of the protrusion 45 and the recess 52 can be changed as appropriate.

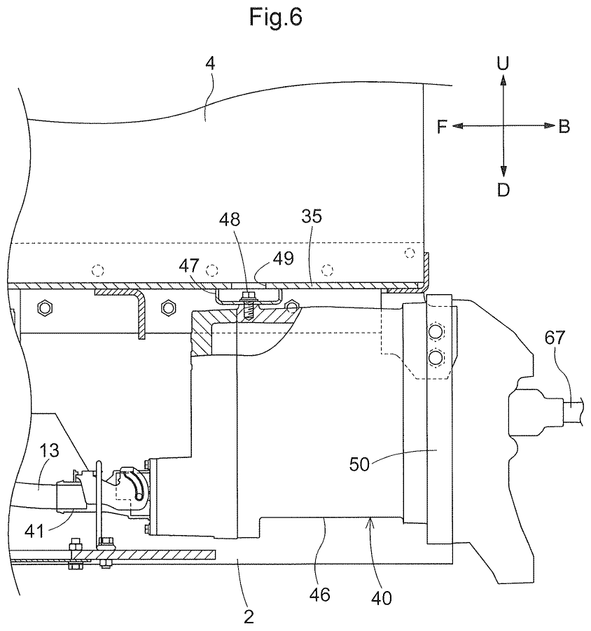

As shown in FIG. 6, the motor 40 may be held other than in a cantilever manner. In the example shown in FIG. 6, a coupling portion 47 and a coupling bolt 48 are provided. The coupling portion 47 may be formed by bending a plate material bent into a channel shape. The coupling portion 47 is coupled to a lower surface of the support frame 35, while protruding downward from the lower surface of the support frame 35. The lower surface of the coupling portion 47 contacts an upper end portion of the housing 46.

The coupling portion 47 is coupled to the upper end portion of the housing 46 by the coupling bolt 48 which extends in the up-down direction. With this structure, the coupling portion 47 and the support 50 hold the motor 40.

The support frame 35 includes an opening 49 therein at a position upward of the coupling bolt 48. A worker is able to insert a tool such as a wrench into the opening 49 and tighten or remove the coupling bolt 48 with the tool.

Note that the configurations disclosed in the above-described example embodiments (including the other example embodiments) can be applied in combination with configurations disclosed in other example embodiments as long as no inconsistencies arise. Also, the example embodiments disclosed herein are illustrative, and the example embodiments of the present invention are not limited thereto and can be modified as appropriate within a range that does not depart from the scope of the present invention.

Example embodiments of the present invention can be utilized not only in tractors but also in various electric work vehicles such as combine harvesters, rice transplanters, and construction machines.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An electric work vehicle comprising:
a battery;
a support;
a motor held by the support and drivable by power supplied from the battery;
an inverter configured to convert direct-current electric power from the battery into alternating-current electric power and supply the alternating-current electric power to the motor;
a harness connecting a front portion of the motor to the inverter; and
a positioning mechanism (i) including a first guide portion on one of the motor and the support and a second guide portion on the other of the motor and the support, and (ii) configured to position the motor relative to the support as viewed in a front-back direction, by the first guide portion and the second guide portion coming in contact with each other;
the inverter being configured to supply power to the motor through the harness;
the motor being held by the support with an output shaft of the motor extending rearward through the support;
the support including a support front surface that is a front surface of the support in which a recess is recessed rearward;
the motor including a contact surface contacting the support front surface and a protrusion protruding rearward from the contact surface and fitting into the recess;
the protrusion being made of a first material;
the support being made of a second material having a higher hardness than the first material; and
at a time of attaching the motor to the support, the first guide portion and the second guide portion of the positioning mechanism are contactable with each other while the protrusion is forward of the support front surface.

2. The electric work vehicle according to claim 1, wherein
the first guide portion includes a pin extending in the front-back direction;
the second guide portion includes a hole that fits together with the pin; and
the positioning mechanism includes a plurality of positioning portions each including one first guide portion and one second guide portion that correspond to each other.

3. The electric work vehicle according to claim 2, wherein the positioning mechanism includes at least three positioning portions.

4. The electric work vehicle according to claim 2, wherein the positioning mechanism includes three positioning portions positioned to define a triangle with vertices at respective positions arranged so as not to define an equilateral triangle, as viewed in the front-back direction.

5. The electric work vehicle according to claim 2, wherein the positioning portions are positioned upward and downward of an axis of the output shaft.

6. The electric work vehicle according to claim 5, wherein the positioning portions upward of the axis are greater in number than the positioning portions downward of the axis.

7. The electric work vehicle according to claim 2, wherein the pin (i) is attached to a pin attachment surface that is the support front surface or the contact surface, (ii) protrudes forward or rearward from the pin attachment surface, and (iii) is longer from the pin attachment surface to a protruding end thereof than a protruding length of the protrusion.

8. The electric work vehicle according to claim 7, wherein
the protruding end of the pin includes a tapered portion; and
the pin is longer from the pin attachment surface to a base end of the tapered portion than the protruding length of the protrusion.

9. The electric work vehicle according to claim 2, wherein
the pin is attached to the motor; and
the hole is provided in the support.

10. The electric work vehicle according to claim 2, wherein
the motor is fastened to the support by a fastener; and
the positioning portions are inward of the fastener in a radial direction of the output shaft.

11. The electric work vehicle according to claim 1, wherein the support holds the motor in a cantilever manner.
